(19) United States
(12) Patent Application Publication
(10) Pub. No.: US 2009/0224934 A1
(43) Pub. Date: Sep. 10, 2009

(54) Caneye process

(76) Inventor: Sharon Collier Medley, Anniston, AL (US)

Correspondence Address: Sharon Collier Medley, 182 Jona Drive, Alexandria, AL, 36250, US

(21) Appl. No.: 12/006,865

(22) Filed: Mar. 4, 2008

(51) Int. Cl. G09B 21/00; G09B 21/04

(52) U.S. Cl. 340/825.19

(57) ABSTRACT

The Caneye Process consists of using radio frequency identification (RFID) to aid the visually handicapped pedestrian who relies solely on the use of a telescopic cane to navigate and who cannot hear a hybrid vehicle, which emits little or no engine noise, at intersections, which is achieved by placing an RFID tag or transponder, which is a microchip attached to a tiny antenna, on the handle of the cane with a corresponding RFID reader or Interrogator mounted in the hybrid vehicle, sounding an alarm in the tag when within a set distance, and the same tag can also be used for the blind to determine the location of elevators in buildings with the aid of Interrogators mounted near elevator entries.

The CANEYE PROCESS for the visually impaired incorporates radio frequency identification (RFID) between a microchip/transponder located in hybrid vehicles as well as on the entry (beneath the Braille sign) to public elevators which corresponds with an interrogators/reader attached to the handle of the telescopic cane used by those who are without sight.

An active tag, as opposed to a passive tag, has its own power source (battery) which is used to power the integrated circuits and to broadcast the signal to the reader/interrogator. The CANEYE PROCESS will work similarly to the RFID technology which the automobile industry uses in placing a tag on the car key ring, and which will start a car or truck at considerable distance.

The CANEYE (pronounced cane-eye) PROCESS, based on radio frequency identification (RFID) technology, which is a process using an active tag and a corresponding interrogator.

### CROSS-REFERENCE TO RELATED APPLICATIONS

Not Applicable

### STATEMENT REGARDING FEDERALLY SPOSORED RESEARCH OR DEVEOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Upon hearing a partial comment on a radio morning program, I learned that a lady who represented the blind in some capacity had complained to the automobile industry that the visually impaired pedestrian could not hear an approaching hybrid vehicle, which emits little or no engine noise, at intersections. As for locating public elevators, I, who am sighted, have had difficulty in doing so. I immediately thought of radio frequency identification (RFID), and proceeded to learn more of the technology.

As use of the hybrid vehicles increases, it stands to reason that the visually handicapped should be prepared to have a safe manner in which to navigate with a cane and not having to rely on a seeing-eye dog. As for locating public elevators, which can be difficult even for the sighted, and would be out of a seeing-eye dog's abilities.

With the rapid advancement of RFID technology, the interrogator will become smaller, becoming practical for placement on the telescopic cane handle.

### BRIEF SUMMARY OF THE INVENTION

The CANEYE PROCESS, made possible by existing RFID technology, will quickly become more practical with advancements in that field.

As the use of the hybrid vehicle increases, the virtually noiseless engine could become a dilemma for the visually handicapped pedestrian. The CANEYE PROCESS would be a preferable alternative to a seeing-eye dog for those who are not animal lovers, as well as whatever other reasons that would make owning a seeing-eye dog impractical.

The CANEYE PROCESS, if adopted by the automobile industry and the manufacturers of telescopic canes, would serve to give the sightless pedestrian confidence as well as to give less risk of hitting a blind pedestrian for drivers of hybrid vehicles. The process could also make it easier for the blind to locate public elevators.

### BRIEF DESCRIPTION OF THE SEVERAL VIEWS OF THE DRAWING

Not Applicable

### DETAILED DESCRIPTION OF THE INVENTION

My invention, the CANEYE PROCESS, dependent on a modest working knowledge of radio frequency identification (RFID), is the process of warning the visually impaired pedestrian of an approaching hybrid vehicle, which emits little or no engine noise, at intersections as well as directing the visually impaired to the vicinity of public elevators in multi-floored buildings.

I propose that this process can be achieved through an RFID interrogator/reader which can be attached to the handle of the telescopic cane which the blind use to navigate. The interrogator may be attached to the cane either at factory level or to those already in possession.

The corresponding transponder, AKA tag, may be installed to the hybrid vehicle, and beneath the Braille sign on public elevator entries.

The RFID interrogator/reader is both a transmitter and a receiver that emits a signal, a small frequency radio wave, to an RFID tag, and receives information from an RFID tag.

The RFID transponder or tag consists of a microchip which contains information and electronic circuits to relay information to an interrogator/reader. It also contains an iron core wrapped in copper wire which acts as a radio antenna, ready to receive a signal from interrogator/reader. It also contains a small capacitor which acts as a tuner, forming an LC circuit with the antenna coil. (An LC circuit consists of an inductor, represented by the letter L, and a capacitor, represented by the letter C. When connected together, an electrical current can alternate between them, at an angular frequency (a measure of how fast an object is rotating). LC circuits are key components in many applications such as oscillators, filters, tuners, and frequency mixers, which are all involved in the receiving and transferring information in the process of RFID.

The RFID interrogator is an electronic device which contains a receiver that holds an amplifier and a demodulator, a transmitter that holds a modulator and a power amplifier, an oscillator, a controller/processor, and an input/output port to an antenna.

When receiving, the amplifier “expands” the signal received from the tag (in this case, located on the hybrid vehicle), through the interrogator antenna (in this case, located on the handle of the telescopic cane) for processing, and the demodulator extracts the information from the signal.

The controller/processor performs the data processing functions and manages the communications with the external network.

When transmitting, the oscillator provides the carrier signal to the modulator and a reference signal to the demodulator circuits. The modulator adds information to the signal to be transmitted to a tag. Then the power amplifier amplifies the modulated signal and reroutes it to the antenna. The antenna radiates the signal to a tag.

To state simply, the active tag located on the hybrid vehicle or on elevator entries, will receive a signal from the interrogator/reader located on the handle of a telescopic cane. In turn, it will transmit a signal to the interrogator/reader, which will respond with an audible alarm in the case of an approaching hybrid vehicle, or in the case of public elevators, it will create an audible signal in the tag located at elevator entries. In the case of tags used at elevator entries, the beckoning signal, can be programmed to be muted and broadcast at reasonable intervals.

What is claimed is: A new method in using radio frequency identification (RFID) by the process of alerting the visually handicapped pedestrian of an approaching hybrid vehicle at intersections as well as the locating of elevators in buildings.

1. RFID tag or transponder is to be placed on the handle of cane of blind person.

2. RFID reader or Interrogator is to be mounted in hybrid vehicles and near elevator entries.
